(19) United States
(12) Patent Application Publication
(10) Pub. No.: US 2010/0152897 A1
(43) Pub. Date: Jun. 17, 2010

(54) METHOD & APPARATUS FOR CONTROLLING THE ATTITUDE OF A CAMERA ASSOCIATED WITH A ROBOTIC DEVICE

(76) Inventor: JEFFREY MULLER, Stow, MA (US)

Correspondence Address: ROBERT SCHULER, 45 GROTON ROAD, SHIRLEY, MA, 01464, US

(21) Appl. No.: 12/335,711

(22) Filed: Dec. 16, 2008

(51) Int. Cl. B25J 19/04; B25J 13/00

(52) U.S. Cl. 700/259; 901/47

(57) ABSTRACT

A robot movement control device is connected to a communications network in a remote location relative to a robotic device that is also connected to the communications network. The robot movement control device is an electronic device with a video display for displaying a real-time video image sent to it by a camera associated with the robot. A robot movement control mechanism is included in the robot control device and robot movement control commands are generated by the movement control mechanism which commands include speed and directional information. The control commands are sent by the robot control device over the network to the robot which uses the commands to adjust its speed and direction of movement of the robot. A relationship between the motion of the robot and the attitude of the camera associated with the robot is establish and used in conjunction with the detected motion of the robot to automatically adjust the attitude of the video camera associated with the robot.

### FIELD OF THE INVENTION

The invention relates generally to the control of a robotic device and specifically to the automatic control of a camera associated with the robotic device.

### BACKGROUND

Mobile, electro-mechanical devices such as robotic devices are designed to move around their environment, whether this environment is inside a building or an outside environment. Some of these robotic devices are designed to move autonomously and some are designed to move according to user generated commands. Commands to control the movement of a robotic device can be generated by a user locally, with respect to the robotic device, such that the user is able to directly observe and then control the robotic devices movement with a wireless control module for instance, or commands to control the movement of a robotic device can be generated remotely by a user and sent over a network for delivery to the robotic device by a wireless router or access point with which the robotic device is associated. In the event that the movement commands are generated by a user from a location remote to the robotic device, it can be important that the user has some sort of visual reference of the environment in which the robotic device is moving. This visual reference can be a schematic or map of the environment local to the robotic device or this visual reference can be a real-time video image of the environment local to the robotic device. In either case, it is useful to have this visual reference when remotely controlling the movements of a robotic device in its environment.

Depending upon the application, it can be satisfactory that the visual environmental reference is a floor-plan schematic of the environment in which the robotic device is located, or it may be more useful to have a video camera attached in some manner to the robotic device which can deliver real-time video information that is helpful to the user when controlling the movement of the robotic device from a remote location. So, for example, in the case were a robotic device is moving around in an environment in which most or all of the objects in the environment are fixed, a schematic representation of the local environment can be satisfactory. On the other hand, in the case were the robotic device is moving around in an environment that includes other objects that are moving around or an environment in which it is expected to interact with people, is can be more useful to have a real-time video image of this environment available to a remote user. Typically, the attitude of a video camera attached to a robotic device can be controlled, which is to say that its pan and tilt can be controlled, independently of the movement of the robotic device. The camera pan/tilt control can be affected manually or automatically, again depending upon the application. So in the event that the function of the robotic device is primarily to interact with people, it may be best that the camera automatically point in the direction of the person speaking at the time. This can be accomplished if the robot includes some sort of sound localization application. Or in the case where the operation of the robotic device is primarily directed to visual as opposed to audio cues, the camera can be manually controlled by the remote user. However, it may not always be possible or convenient to manually control the operation of the camera while the robot is moving around its environment.

Typically, a robotic movement control module is implemented as either a wireless, hand-held module if the control is local or an application running on some sort of computational device connected to a network if the control is remote. In the case where user control is local to the robot, the hand-held device typically includes a joystick mechanism that is employed by the user to direct the movement and the speed of a robotic device. U.S. Pat. No. 6,604,022 disclosed such a hand-held device that incorporates a joystick that has eight compass points to direct a robot's movements. In addition to controlling the direction of movement, the joystick is used to control the speed of the robot if it is engaged from more than three seconds, in which case the robot's speed will increase in the direction selected on the joystick. In the case where user control is remote, a virtual joystick may be displayed on a computer screen that can be manipulated to select the direction and speed of a robotic device. So for instance, an icon can be displayed on the computer screen that represents a joystick which is manipulated using a point and click tool such as a mouse to select a direction and speed. Another method used to control the movements of a robot is described in U.S. Pat. Nos. 6,845,297 and 6,535,793. As described in these two patents, a computer screen displays a graphical representation of the environment of a robot and the user defines locations within the representation that are positions to which the robot moves. The user than selects a “go” button on the computer screen and the robot starts to move toward the position defined in the representation at a selected speed. In this case, a camera is attached to the robot that is controlled manually also using camera control icons that are displayed on the computer screen. Yet another method for controlling the movement of a robot is described in US patent application publication no. 2007/0199108A1 in which both a joystick method and a coordinate selection method are used to determine the movement of the robot. In this application, locations in a room or the room to which the user wants the robot to move are selected on a representation of the room or structure that is displayed on a computer monitor screen and the robot is instructed to move to the location selected. Additionally, one or more cameras can be mounted on the robot with one or both of the cameras used to display a “robot perspective” view of its local environment for showing an “eye level” view or a “ground plane” view which shows the floor proximate to the robot and is used for steering the robot. Although all of the robot movement control methods described above are effective means to control the movement of a robotic device in its environment, they are limited to either pre-selecting a position in space to command a robot to move to or they are limited to a real-time movement control icon that, although proximate to the representation of the robot's environment, forces the user to move the focus of their eyes back and forth from the movement control icon to the environmental representation to determine how and when to control a robots movements. This continual visual refocusing from one position on a computer monitor screen used to control a robots movement to another position on the screen that displays the robots movement is a less than ideal method for controlling the movement of a robot. Further, the existing methods for manually controlling a cameras attitude detract from the ease with which the motion of a robotic device is controlled.

### SUMMARY OF INVENTION

Some of the limitations to the manual control of a robot camera are over come by tying the attitude of a camera to the robots motion such that the camera attitude is automatically changed according to the detected change in motion of the robot. A method for controlling the movement of a robot is comprised of establishing and storing a linear or non-linear relationship between the camera attitude and the motion of the robot; initiating an automatic camera control function; detecting the current motion of a robot while the camera is positioned in a first attitude; using the detected robot motion in conjunction with the stored relationship between camera attitude and robot motion in order to determine a second camera attitude; and adjusting the attitude of the camera from the first to the second camera attitude.

### BRIEF DESCRIPTION OF THE DRAWINGS

FIG. 1 is a diagram of a communications network showing the elements necessary to carry out the invention.

FIG. 2A is a functional block diagram of a robotic device movement control module.

FIG. 2B is a functional block diagram of robotic device movement functionality.

FIG. 2C is a graphical representation of three camera attitude-robot motion relationships.

FIG. 3 is a representation of the local environment in which the robotic device moves.

FIG. 4 is an illustration of a robot movement control overlay.

FIG. 5 is an illustration of the combined local environment representation and the direction/speed overlay.

FIG. 6 is a logical flow diagram of the operation of the invention.

### DETAILED DESCRIPTION

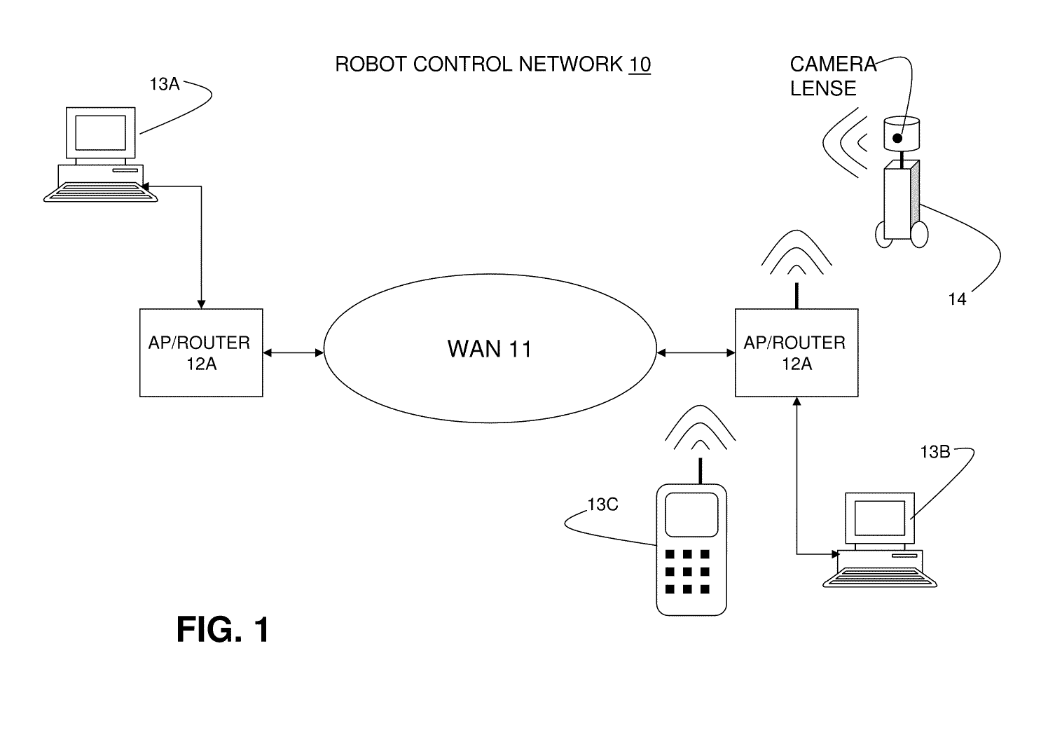

Typically, there are two classes of mobile robotic devices. One class of device can move around their environment autonomously and a second class of device can be commanded to move around their environment manually. Mobile robotic devices exist that combine both automatic movement and movement under manual control; however, this description is directed primarily too mobile robotic devices that are manually controlled to move around their environment. This manual control of a robotic device's movement can be performed in a location remote from the robotic device or it can be performed locally to the robotic device. FIG. 1 shows a robot control network 10 that includes a wide area network (WAN) 11, two routers or access points 12A and 12B, three robot control devices 13A, 13B and 13C and a mobile robotic device 14 which will be referred to simply here as a “robot”. The WAN 11 can be a public network such as the Internet or a private, enterprise network and it generally operates to support the transmission of robot control commands from a remote location, such as the location of the robot control device 13A, to the robot 14. FIG. 1 shows two routers or access points 12A and 12B connected to the WAN 11 which operate to receive robot control commands from any of the three robot control devices 13A-C and transmit the command, over a wireless medium, to the robot 14. As shown in FIG. 1, router 12A is a wired device, that is, it is connected to the WAN 11 and to the robot control devices 13A in a hard-wired manner which can be an Ethernet cable for example. Also as shown in FIG. 1, router 12B is a wireless device that can be connected to the WAN 11 via an Ethernet cable and which communicates with the robot 14 in a wireless manner. The 802.11b wireless communication protocol can be implemented on router 12B in order to support the transmission of robot control commands between router 12B and the robot 14 in a wireless manner, although any wireless communications protocol with a range appropriate to the application can be employed. Each of the robot control devices 13A-13C can be a different type of electronic device capable of creating and transmitting a robot control command. Control device 13A can be a desk-top computer, device 13B can be a lap-top computer and device 13C can be a hand-held communications device, for instance. In the event that the movement of the robot 14 is controlled from a remote location, control device 13A is employed by a user to generate a robot movement control command that is transmitted over the network 10 to the robot 14 which receives that command and executes a movement or movements according to instructions included in the command. According to one embodiment of the invention, each of the robot control devices 13A-13C includes a robot movement control module that implements a robot movement control function that visually overlays a real-time video image of the robot's environment. The movement control overlay is manipulated by a user to generate robot movement control commands without the need to look away from the video display which is a real-time representation of the robots location within its environment. The robot movement control command can be employed to automatically control the attitude or the tilt of a camera associated with the robot 14. It should be understood, that although the automatic camera control method is described here in the context of a robot movement control function that visually overlays a real-time video image of the robots environment, any robot movement control functionality can be employed. So, for instance, robot movement can be controlled using a joy stick, keyboard commands, or any other methods that can be employed to control the movement of a robot.

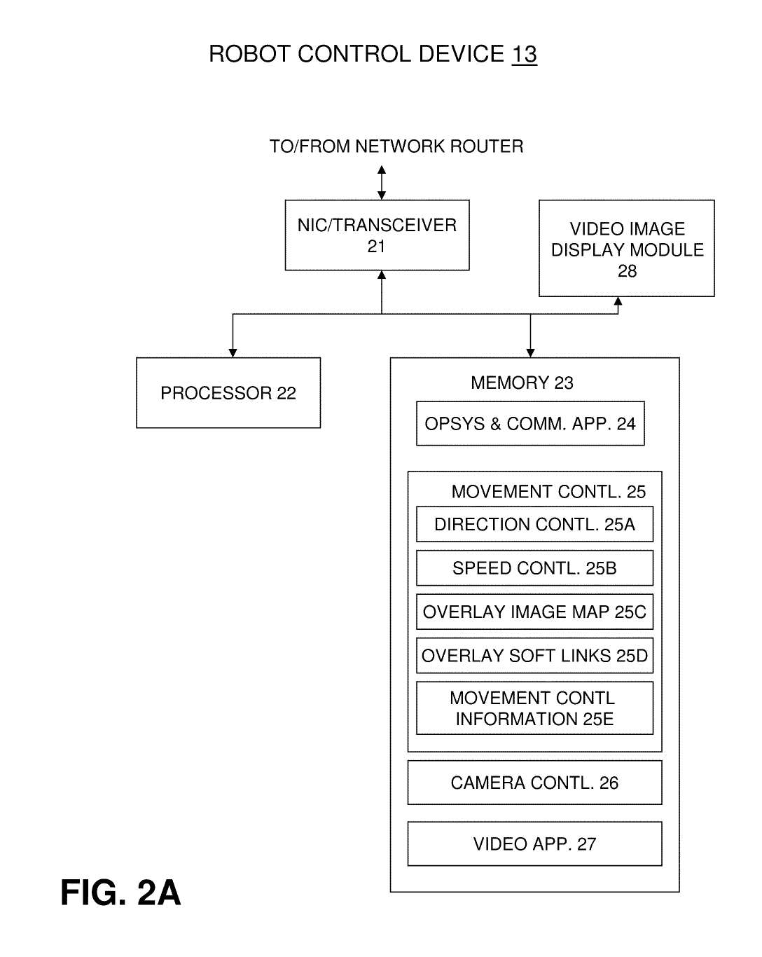

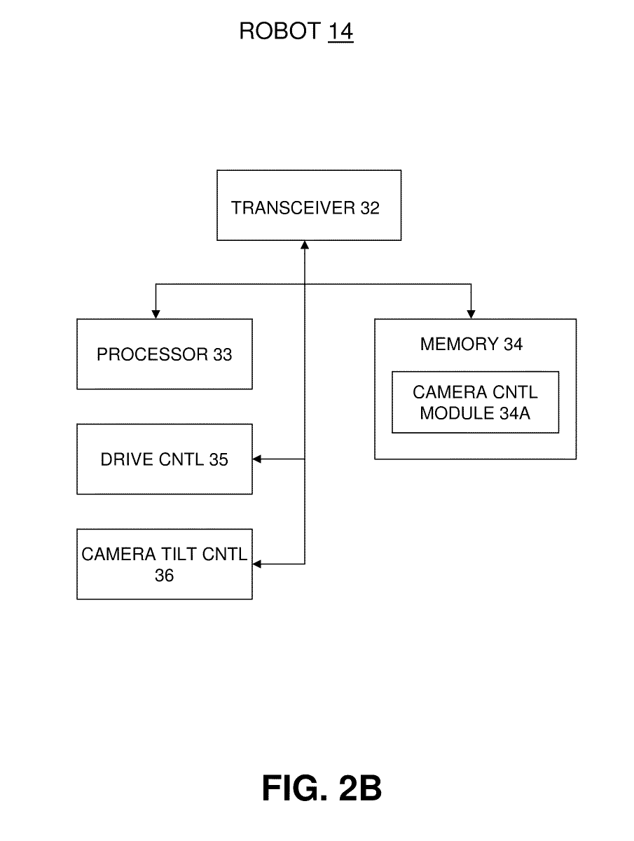

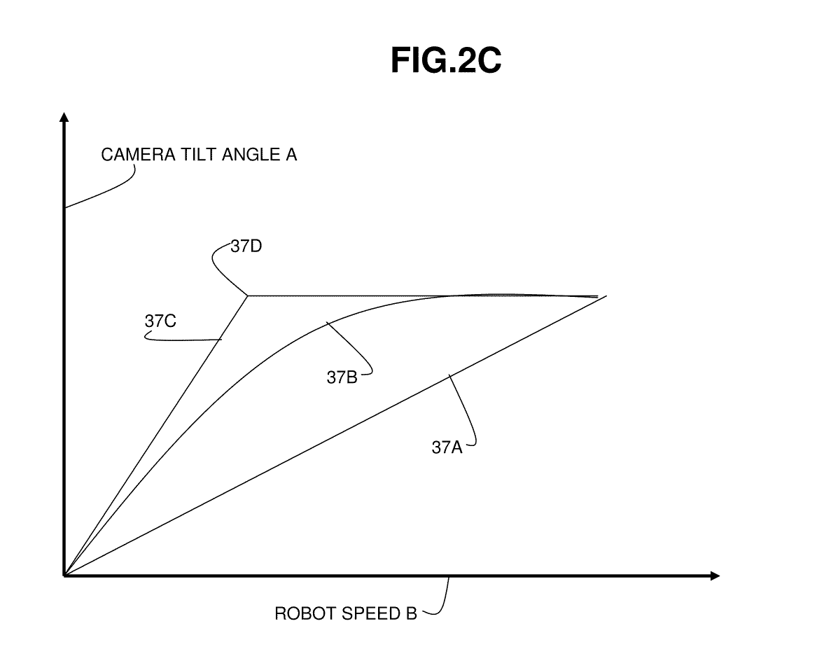

FIG. 2A is a diagram showing the functional elements, included in any one of the robot control devices, 13A-13C, that are necessary to implement the preferred embodiment of the invention. For the purpose of this description, the robot control devices 13A-13C are referred to collectively as control device 13. According to whether the control device 13 is connected to a router in a wired or wireless manner, it includes either a network interface card (NIC) or a transceiver module 21 for sending and receiving messages over the network 10, which messages, among other things, include robot movement control commands. Control device 13 also includes a processor module 22 which operates according to instructions and commands included in several functional modules stored in a memory 23 to effect the operation of the control device 13 and, among other things, to display a real-time video image of a robots environment on a video image display module 28. The functional modules stored in memory 23 include an operating system and communication application module 24, a robot movement control module 25, a camera control module 26 and a real-time video application module 27. The operating system and communication application module 24 can be separate modules, but for the purpose of this description are considered to be one module as they do not have any direct effect on the operation of the invention. The operating system portion of module 24 includes general instructions and commands that are used by the processor 22 to coordinate the operation of the control device 13. These can be such operations as moving video information into and out of memory for display on the video image display device 28, transferring a message that includes a robot control command to the transceiver or NIC for transmission to a robot, or executing instructions to create robot movement control commands based on user commands generated as the result of manipulating the movement control overlay. Several operating systems are commercially available and are appropriate for use in such applications depending upon the platform that is used for a robot control module. The communication application can be either a wireless communication application or a wired communication application. In the event that a robot control module transmits messages to a robot wirelessly, the communication application can be based on the well know IEEE 802.11b standard communications protocol, and in the event that a robot control module transmits messages to a robot over a wired connection, the communication application can be based on the Ethernet standard communications protocol.

Continuing to refer to FIG. 2A, the robot movement control module 25 included in memory 23 is comprised of five sub-modules; namely, a robot direction control module 25A, a robot speed control module 25B, a movement control overlay image map store 25C, a soft link store 25D and a robot movement control information store 25E. The robot direction control module 25A controls the rotational direction and rotational speed, hereinafter referred to simply as direction, of the robot by sending different drive speed control signals to each of the driving members (wheels) of the robot. So if the robot has two drive wheels, a drive signal can include information to rotate a left one of the two wheels one revolution per second and the drive signal can include information to rotate a right one of the wheels two revolutions per second. The result is that the robot will rotate to the left at the selected speed for as long as this particular drive signal combination is applied. The robot speed control module 25B controls the linear speed of the robot by sending a control message to the robot that includes information that controls the revolutions per second at which both drive wheels of the robot rotate. The overlay image map store 25C stores a listing of pixel coordinates that define the appearance of a robot movement control overlay that appears in the field of a real-time video image displayed on the video image display module 28 associated with the robot control device 13. The overlay image can be created using an alpha blending technique that is available in many computer graphic development applications. In the preferred embodiment, this overlay appears in the field of the real-time video image whenever a control pointer, such as a pointer associated with a pointing device such as a computer mouse, is moved into the real-time video image field. The overlay soft link store 25D is comprised of a listing of coordinate groups, each group representing one robot movement control soft link that resides within the bounds of the visual overlay. Each soft link is associated with a single set of robot movement control information stored in the robot control information store 25E. Each robot movement control information set includes robot rotational direction and rotational speed and robot speed information that is sent to the robot direction control module 25A and robot speed control module 25B respectively to be included in a control message sent to the robot which when processed by a robot results in the robot moving towards a particular direction at a particular speed.

With further reference to FIG. 2A, the camera control module 26 includes functionality that can automatically control the attitude of a robot's camera according to the robots motion, which can be the linear speed at which the robot is moving. More specifically, different camera tilt and/or pan angles and camera lens zoom factors can be strategically assigned to different robotic motion (linear speed or rotational direction/speed) in order to establish a camera attitude-robotic device motion relationship, and each instance of the robot motion-camera attitude relationship is stored in memory 23 as an automatic camera control or attitude instruction. The camera control module 26 can operate to examine the current robot motion information stored in the movement control information store 25E and depending upon the current speed or motion of the robotic device, the camera control module 26 can generate a message that causes the automatic camera attitude instructions stored in memory 23 to be examined, and the instruction that corresponds to the current speed is selected. Alternatively, the attitude of the robots camera can be calculated on-the-fly using the speed and/or the rotational direction of the robotic device. In this case, the current speed of the robotic device can be applied to an equation, such as Equation 1 below, which represents the relationship between robot motion and camera attitude and determines in real-time the current attitude that the camera should assume. The attitude can be a tilt angle, a pan angle or a zoom factor.

Camera Angle=angleₘᵢₙ+(horizontal−angleₘᵢₙ)*speed/speedₘₐₓ Equation 1

Equation 1 is derived to result in a linear relationship between the camera attitude and the speed of the robotic device; however, this relationship need not be linear in nature. In Equation 1, the first term “Camera Angle” is the resulting angle that is included in a message that is sent to the robot camera tilt/attitude mechanism. The second term “angleₘᵢₙ”, is the minimum tilt or pan angle or zoom factor that the camera can assume and is typically a fixed value. This angle can be as little as zero or as much at ninety degrees. The third term “angleₘᵢₙ+(horizontal−angleₘᵢₙ)” simply subtracts the value of the second term from the value of “horizontal” which is typically fixed at ninety degrees for instance. In this case, horizontal indicates that the camera's center of focus is on the horizon which would typically be a value of ninety degrees. And finally, the last term “speed/speedₘₐₓ” is assigned a value that corresponds to the current linear or rotational direction of the robot divided by the maximum programmed speed of the robot.

After the camera attitude is determined, the camera control module 26 can generate a message, which includes the camera attitude instruction corresponding to the current speed, and this message is transmitted to the robot camera tilt mechanism not shown. Mechanisms employed to move the tilt angle of a camera are well know in the art and so will not be described here. In operation, when a robot is at rest, the camera tilt angle can be controlled manually to be any particular angle or it can be controlled automatically to be at a specified tilt angle. In automatic operation, when the automatic camera control functionality is selected, the camera attitude automatically assumes a position that corresponds to the current speed or rotational direction of the robot. As the speed of the robot increases, the tilt angle of the camera increases providing the user with a more forward looking view of the robot's environment which allows the user to very easily control the robot's movements at the higher rate of speed, and as the speed of the robot decreases, the tilt angle of the camera decreases providing the user with a more downward looking view of the robots environment. The camera can assume a tilt angle that ranges from zero degrees to 90 degrees, where the zero degree position is equivalent to the camera pointing in a vertically, downward direction toward the base of the robotic device and the ninety degree position is equivalent to the camera pointed in a horizontal direction at ninety degrees from the vertical position. Similarly, as with the tilt angle, the camera control module 26 can control the camera to pan in the direction that the robot is turning in order to better view objects in the direction of the turn. The camera control module 26 can also operate to control the zoom factor of the camera lens. So, for instance, as the camera tilt angle increases towards the horizontal attitude and the robot linear speed increases, the camera lens can be controlled to zoom in order to better view distant areas in front of the robot.

In an alternative embodiment, an actual physical camera may not be included with the robotic device. In this “virtual camera” embodiment, the robotic device can generate a virtual or schematic view of its environment for observation by a remote user. As with the case in which an actual camera is used, as described above, the schematic or virtual view of the robotic devices environment can change according to the motion of the robot. In this alternative embodiment, the camera control module 26 can include an automatic environmental view function that contains information that generates the virtual or schematic view of the robotic device's environment that changes with the motion of the robotic device such that a remote user can observe a view that appears to change with respect to tilt an angle, pan an angle or zoom factor.

Although the automatic camera attitude functionality is described above in the context of a robot control overlay displayed in a real-time video image, the invention can just as easily be implemented without such a control method and is not limited to such a robotic device control mechanism. The automatic camera attitude functionality can just as easily be implemented on a robotic device that is control with a physical or virtual joy stick or any other robotic device speed or rotational direction control mechanism.

FIG. 2B illustrates a second embodiment of a robot control arrangement in which the camera control functionality 26 is implemented on the robot 14 as opposed to being located in the robot control module 13 of FIG. 2A. FIG. 2B shows the robot 14 including, among other things, a transceiver 32 for receiving robot control messages from a robot control module and a processor 33 connected to the transceiver 32 and a memory 34 that generally operates in conjunction with functionality stored in the memory 33 to control the operation of the robot 14. The memory 34 stores functionality used by the processor to automatically generate camera pan/tilt control signals. More specifically, the memory 34 includes, among other things, a camera control module 34A. The camera control module 34A in conjunction with the processor 33 uses the robots linear and rotational speed information contained in a robot control message received from a robot control module to automatically generate a camera attitude instruction that is sent to the camera drive control module 35. This camera attitude instruction contains information that the camera drive control module 35 uses to control the attitude of the camera. In operation, and assuming that the camera attitude being controlled is tilt an angle, when a robot is at rest, the camera tilt an angle can be controlled manually to be any particular an angle, referred to here as a first camera attitude, or it can be controlled automatically to be at a specified tilt an angle. In automatic operation, when the automatic camera control functionality is selected, the camera tilt automatically assumes a first an angle that corresponds to the current speed and/or rotational direction of that robot. As the speed of the robot increases, the tilt an angle of the camera can channel to a second an angle to provide the user with a more forward looking view of the robot's environment which allows the user to very easily control the robot's movements at the higher rate of speed, and as the speed of the robot decreases, the tilt an angle of the camera can be controlled to decrease providing the user with a more downward looking view of the robots environment. Such automatic camera operation is useful when a robot's speed is slow in order to navigate around or through an obstacle. Typically, at slower speeds, it is desirable to view the surface, proximate to the robot, over which the robot is moving as obstacles, such as furniture or doorways, are more easily avoided or passed through at slow speeds and it is important to know where the footprint of the robot is in relation to the obstacles when controlling the robots movement. Conversely, when the robot is moving at higher rates of speed, it is most often desirable to observe the robots environment that is at some distance from the robot. This manner of controlling the attitude of a camera greatly simplifies the process of controlling the motion of a robot for the user. By employing this method, there is no need for the user to attempt to control the speed and direction of the robot as well as attempting to control the attitude of the robot's camera so that it displays the most appropriate view of the robot's environment.

FIG. 2C is a graphical representation of three relationships that can be established between camera tilt angle, shown on the vertical axis A, and robot speed, shown on the horizontal axis B. The three camera tilt angle/robot speed relationships appear in FIG. 2C as the straight line 37A, the curved line 37B and the angled line 37C. Line 37A is the plot of a linear relationship between camera tilt angle and robot speed and shows that the tilt angle increases at a consistent rate through the range of speed of the robot. Line 37B is a plot of a non-linear relationship between camera tilt angle and robot speed and show that the rate at which the tilt angle changes depending upon the speed of the robot, such that the angle changes faster at a lower robot speed and more slowly at a faster robot speed. Line 37C is the plot of two different but continuous linear relationships between camera tilt angle and robot speed. I this case, the tilt angle rapidly increases as the speed of the robot increase to a particular rate of speed at point 37D, and from this point until the robot reaches maximum speed, the camera tilt angle remains unchanged.

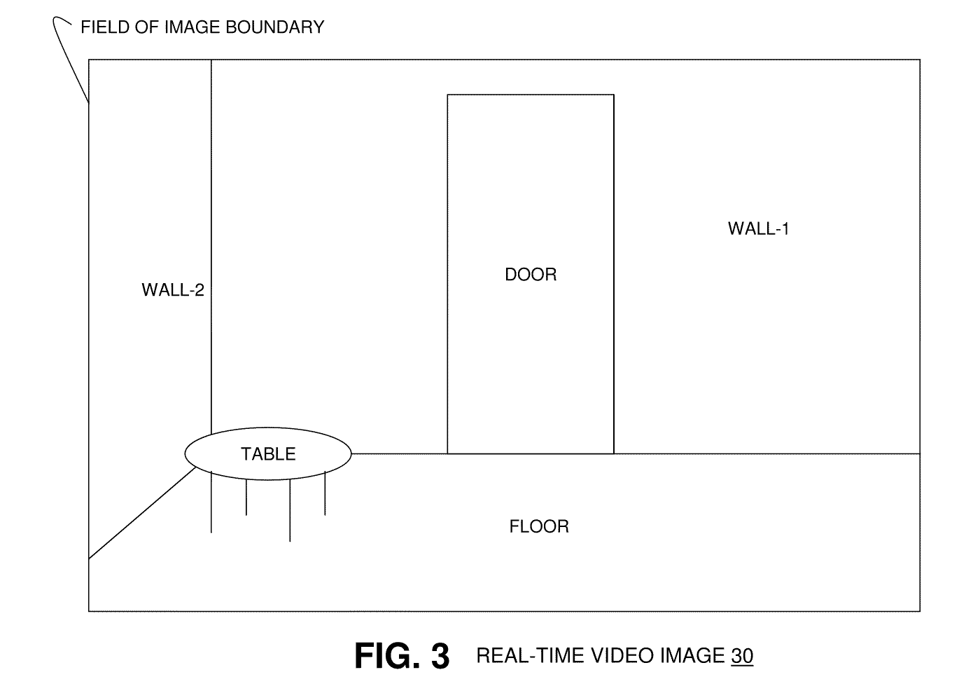

FIG. 3 is a graphical representation of a real-time video image 30 of a robot's camera view of its local environment that is displayed at a control module, such as the control module 13A in FIG. 1. This real-time video image shows a portion of a room with two walls, wall-1 and wall-2, a door, a table and a floor all of which are confined to a particular display window 31. This window can occupy a portion or all of a robot control monitor screen either of which window format size can be selected by a user.

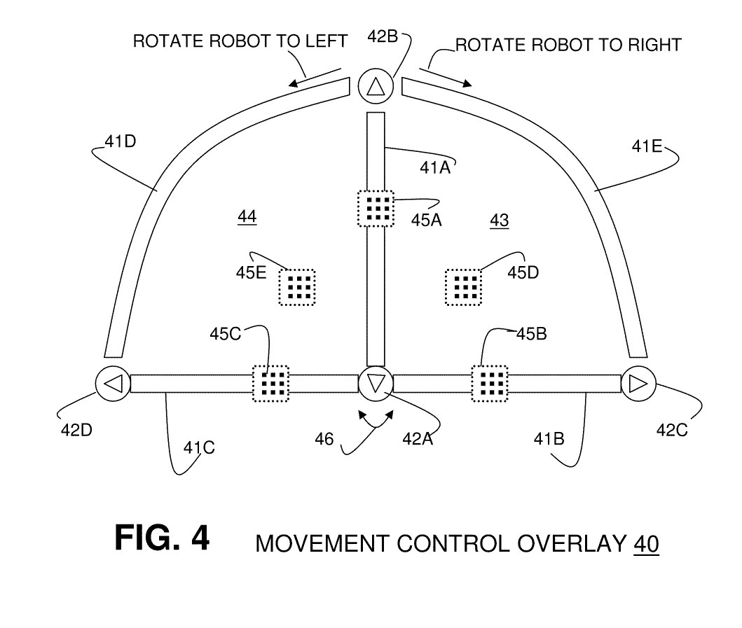

FIG. 4 is an illustration of a robot movement control overlay 40 that is employed by a user to control the rotational direction and speed of a robots movement in its environment. This overlay is displayed in the field of the real-time video image 30 as the result of a user moving a control pointer into the field of the video image. Control overlay 40 includes two movement control sectors 43 and 44. Movement control sector 43, which includes rotational direction and speed information to control robot movement in a direction to the right of the current robot direction, is bounded by three movement control elements 41A, 41B and 41E, and movement control sector 44, which includes rotational direction and speed information to control robot movement in a direction to the left of the current robot direction, is bounded by three movement control elements 41A, 41C and 41D. A point along the movement control element 41A is selected to control the straight ahead movement of a robot. The speed at which the robot moves in this direction is controlled to be greater or lesser by selecting different points that fall on control element 41A which are respectively farther or nearer to a control point 42A. A point along the movement control element 41B is selected to cause a robot to turn or rotate in place to its right, with respect to its current direction, at a greater or lesser speed depending upon the distance from the control point 42A that is selected on the control element 41B. A point along the movement control element 41C is selected to cause a robot to turn or rotate in place to its left, with respect to its current direction, at a greater or lesser speed depending upon the distance from the control point 42A that is selected on the control element 41C.

With continued reference to FIG. 4, each of the movement control sectors 43 and 44 include a plurality of robot movement control soft links with each soft link being associated with a different location within each of the movement control sectors. For the purpose of this description, five such soft links are shown as 45A, 45B, 45C, 45D and 45E. Each one of the plurality of robot movement control soft links are associate with different robot movement control information stored in information store 25E of FIG. 2. The robot movement control information includes robot forward speed information and rotational direction and speed information used to control the movement of a robot. Each soft link is composed of a programmed number of pixel-coordinate groups. Each pixel coordinate represents the row and column coordinate position in the display screen. VGA displays typically employ a pixel format that includes 640 rows and 480 columns, so a pixel coordinate position can be row 30, column 50 for instance. Each pixel grouping that is included in the control overlay 40, which in this case are represented by the groupings associated with the soft links 45A-E can include the same number of pixel-coordinates or they can include a different number of coordinates. So for instance, all of the pixel groupings that fall on control element 41A, represented here by the single grouping associated with the soft link 45A, can include sixteen pixel coordinates, while the other pixel groups (41B-E) that fall on other areas of the movement control overlay can include nine pixel-coordinates. The inclusion of sixteen pixel-coordinates in the pixel groups associated with the control element 41A permits a user to more easily select a straight ahead robot movement direction than would otherwise be possible if only nine pixel-coordinates were included in these groups. Although the movement control elements 41A, 41B and 41C are illustrated to include only one soft link 45A, 45B and 45C respectively, each control element can typically include more than one such soft link.

Continuing to refer to the motion control elements 41A-C in FIG. 4, as described earlier, control element 41A is selected to move a robot in a straight ahead manner with respect to an initial robot position, control element 41B is selected to rotate a robot in place its right (or in a clockwise direction) with respect to the current direction of the robot and control element 41C is selected to rotate a robot in place to its left (or counter clockwise) with respect to the current direction of the robot. All of these directions are relative to the initial or last direction in which the robot is moving. So if a robot is initially directed to move in a straight ahead manner by selecting a position on control element 41A, and subsequently it is determined that the robot should change direction and move to the right (rotate to the right), then a position to the right of control element 41A, such as the position occupied by soft link 45D in sector 43, is selected. If the robot is to be controlled to turn to the left with respect to its current direction, either a point on control element 41C, represented by soft link 45C, or a point in a control sector 44 of the control overlay 40, represented by soft link 45E, can be selected. If the soft link 45C is selected the robot will rotate more rapidly in the counter clockwise direction as it is moving forward than if the soft link 45E is selected. As referred to above, the positions of each of the soft links 45A-E in the control overlay 40 correspond to a particular speed at which a robot is controlled to move. More specifically, a control point 42A in the control overlay can be considered the origin of the control overlay and this point represents a soft link that points to a control vector that includes information that controls a robot to not move or be at rest. Points selected that are at some distance from this origin 42A are associated with movement control information results in a robot moving at a speed that is greater than zero and rotating in the selected direction at a particular speed.

The motion control overlay 40 of FIG. 4 includes two control elements 41D and 41E that provide a visual indication of the limits of speed in a particular selected rotational direction. If a user positions their pointer device outside or beyond the boundaries of the control overlay defined by the control elements 41B, 41C, 41D and 41E, such a pointer position will not alter the current speed of a robot. In addition to the origin point 42A, control points 42B, 42C and 42D are shown as included in the control overlay 40 and each of these control points are illustrated as positioned at the terminal ends of two or three control elements 41A-E. Each of these control points 42A-E are represented as an arrow surrounded by a circle. A robot rotation control icon 46 is shown proximate to control point 42A and can be manipulated by a user to rotate the robot in a left or a right direction when it is not moving. The arrow in each of the control points 42A-E is an indicator of the direction of rotational movement of a robot.

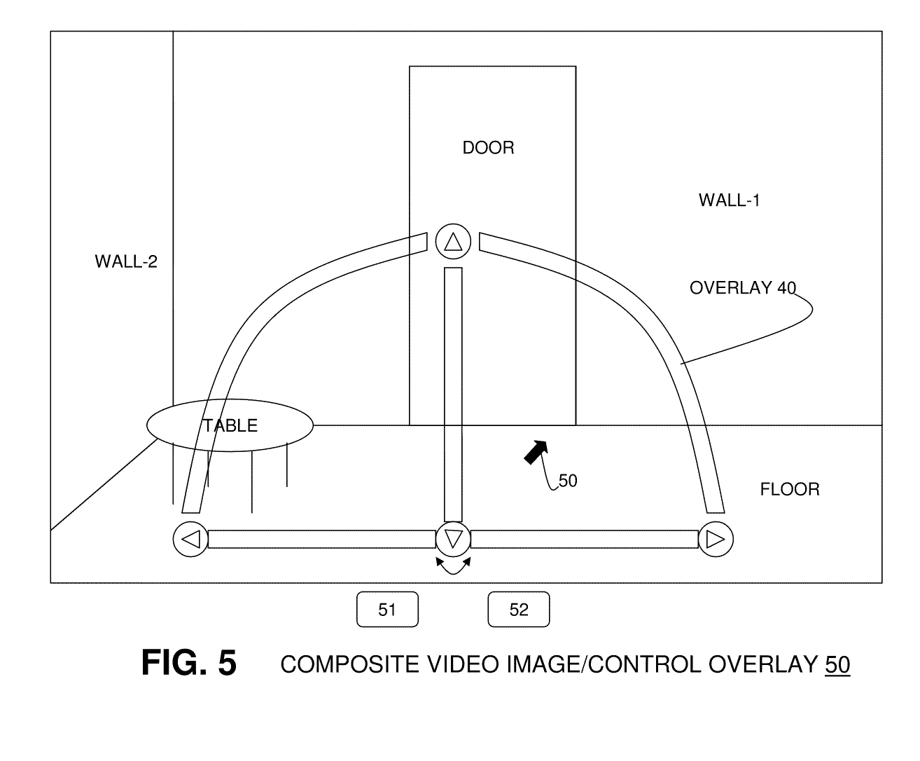

FIG. 5 is a composite representation of the real-time video image 30 of FIG. 3 and the robot movement control overlay 40 of FIG. 4 showing the control overlay 40 in the field of the video image 30, a user controlled pointer 50 and two camera control function soft function that are represented by the areas 51 and 52. As described previously, the control overlay 40 appears in the field of the video image 30 as soon as a user moves the control pointer 50 into the field of the video image 30. By moving the control pointer 50 to a particular position within the boundaries of the control overlay 40 and selecting this position, such as the position occupied by soft link 45D in FIG. 4, a user is able to control a robot to rotate in a direction to the right of a straight ahead direction in which the robot is currently moving at the selected speed, which in the case can be approximately 0.5 feet per second. The two camera control soft functions 51 and 52 are selected to respectively turn on or to turn off the automatic camera tilt functionality.

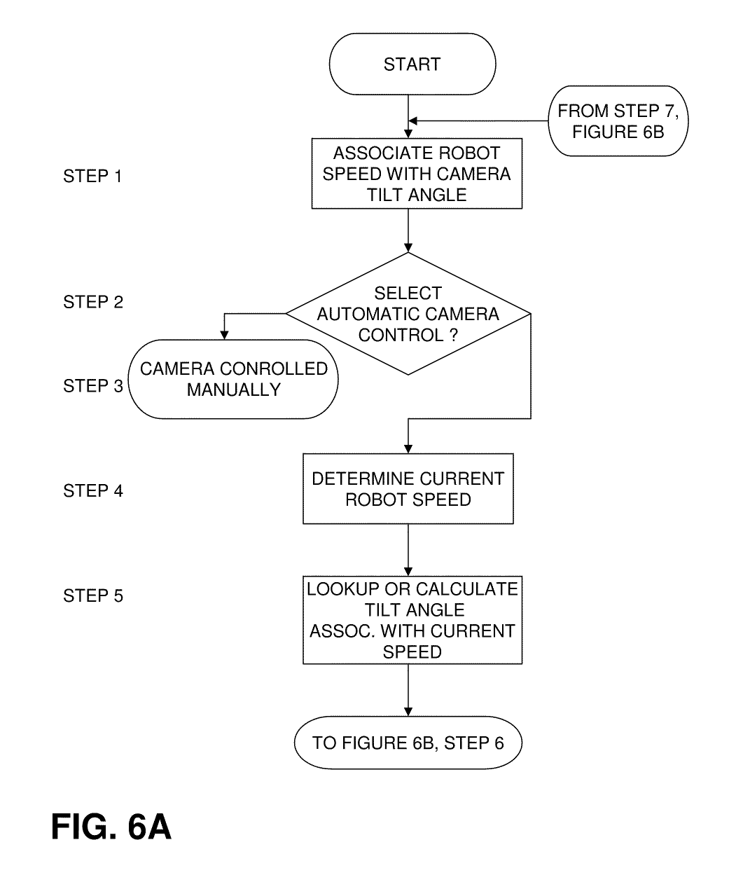

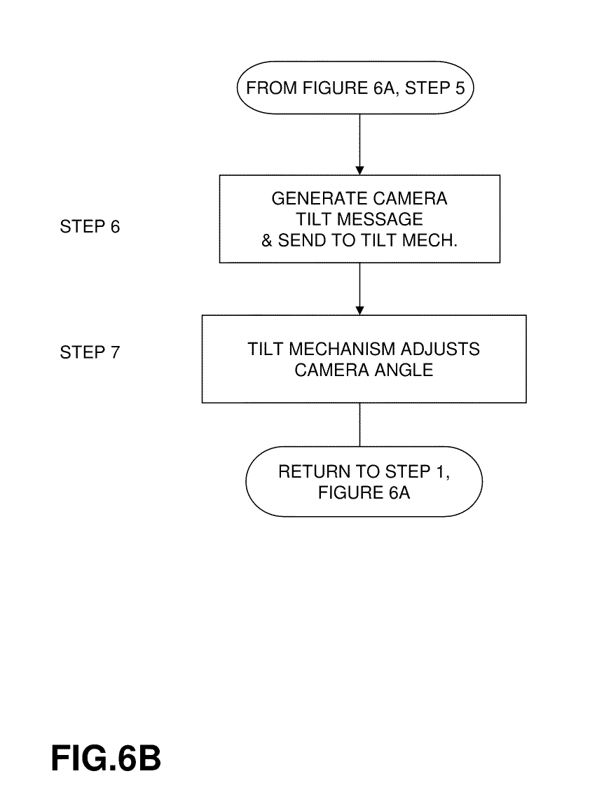

The process employing robot speed information to automatically control the attitude of a camera will now be described with reference to the logical flow diagram of FIG. 6. For the purpose of this description, it is assumed that the camera attitude in this case is camera tilt angle and that robot motion is the linear speed of the robot. In step 1, a range of robot speeds are selected and each robot speed is assigned to be associated with a particular camera tilt angle. Each speed-tilt angle instance is referred to as an instance of a camera angle robot speed relationship. Alternatively, an equation, such the Equation 1 described previously, can be derived that establishes a relationship between camera tilt angle and robot motion. This speed-tilt angle relationship information is then stored in memory 23. In step 2, the automatic camera control functionality is activated by selecting the soft function “S1” shown with reference to FIG. 5. If the soft function “S1” is not selected then the process goes to step 3 and the camera tilt is controlled manually. Otherwise the process proceeds to step 4 and the camera control module 26 examines the movement control information store 25E to determine that current speed (motion) of the robot. The current robot speed is returned to the camera control 26, and in step 5 the current speed of the robot is employed by the control module 26 as a pointer to lookup the camera tilt angle that corresponds to the current robot speed or the current speed is entered into the last term of Equation 1 to determine the proper camera tilt angle. In step 6, the information corresponding to the tilt angle that corresponds to the current robot speed is then placed in a message that is sent to the mechanism that adjusts the camera tilt angle, and in step 7 the tilt mechanism adjusts the tilt of the camera according to the tilt information included in the message. The process then returns to step 1 and continues until the robot is deactivated.

The forgoing description, for purposes of explanation, used specific nomenclature to provide a thorough understanding of the invention. However, it will be apparent to one skilled in the art that specific details are not required in order to practice the invention. Thus, the forgoing descriptions of specific embodiments of the invention are presented for purposes of illustration and description. They are not intended to be exhaustive or to limit the invention to the precise forms disclosed; obviously, many modifications and variations are possible in view of the above teachings. The embodiments were chosen and described in order to best explain the principles of the invention and its practical applications, they thereby enable others skilled in the art to best utilize the invention and various embodiments with various modifications as are suited to the particular use contemplated. It is intended that the following claims and their equivalents define the scope of the invention.

I claim:

1. A method for automatically controlling the attitude of a camera associated with a mobile robotic device comprising:
establishing a relationship between a range of camera attitudes and a range of mobile robotic device motion and storing the relationship;
initiating an automatic camera control function;
detecting the current motion of a mobile robotic device while the camera is positioned in a first camera attitude;
using the detected current mobile robotic device motion and the stored relationship between the camera attitude and robotic device motion to determine a second camera attitude; and
adjusting the attitude of the camera from the first camera attitude to the second camera attitude.

2. The method of claim 1 wherein the camera attitude is one or more of a camera tilt angle, a camera pan angle, and a camera lens zoom factor.

3. The method of claim 2 wherein the camera tilt angle includes a range of angles from zero to ninety degrees, the camera pan angle includes a range of angles from zero to one-hundred eighty degrees and the camera lens zoom factor includes a range of zero to infinity.

4. The method of claim 1 wherein the established relationship between the camera attitude and mobile robotic device motion is a linear relationship or a non-linear relationship.

5. The method of claim 1 wherein the mobile robotic device motion is the linear speed of the robotic device.

6. The method of claim 1 wherein the mobile robotic device motion is the rotational speed of the robotic device.

7. The method of claim 1 wherein the automatic camera control function operates to control the attitude of the camera.

8. The method of claim 1 wherein the current motion of the mobile robotic device is one or both of a linear speed and a rotational direction.

9. An apparatus for automatically controlling the attitude of a camera associated with a mobile robotic device comprising:
A processor; and
A memory associated with the processor, the memory including;
a mobile robotic device movement control module that operates to detect a current robot motion; and
a camera control module that operates to receive robot motion information from the robotic device movement control module and that uses the motion information in conjunction with an established camera attitude-robotic device motion relationship to automatically control the attitude of the camera.

10. The apparatus of claim 9 wherein the camera attitude is one or more of a camera tilt angle, a camera pan angle and a camera lens zoom factor.

11. The apparatus of claim 10 wherein the camera tilt angle is a range of angles from zero degrees to ninety degrees.

12. The apparatus of claim 11 wherein the zero degree camera tilt angle equates to the camera pointed vertically in a downward direction and the ninety degree camera tilt angle equates to the camera pointed in an upward direction that is ninety degrees from the vertical tilt angle.

13. The apparatus of claim 9 wherein the mobile robotic device movement control module operates to control the motion of the mobile robotic device.

14. The apparatus of claim 13 wherein the motion of the mobile robotic device is one or both of a linear speed and a rotational direction of the mobile robotic device.

15. The apparatus of claim 9 wherein the established camera attitude-robotic device motion relationship is a linear or a non-linear relationship.

16. A method for automatically controlling the view of a robotic devices environment comprising:
establishing a relationship between a range of views of the robotic devices environment and a range of mobile robotic device motion and storing the relationship;
initiating an automatic environmental view function;
detecting the current motion of a mobile robotic device in a first environmental view;
using the detected current mobile robotic device motion and the stored relationship between the environmental view and robotic device motion to determine a second environmental view; and
adjusting the environmental view from the first environmental view to the second environmental view.

17. The method of claim 16 wherein the environmental view can be adjusted for any one of a tilt angle, a pan angle and a zoom factor.

18. The method of claim 16 wherein the established relationship is a linear relationship or a non-linear relationship.

19. The method of claim 16 wherein the mobile robotic device motion is one or both of linear speed and rotational speed of the robotic device.
